(19) United States
(12) Patent Application Publication
(10) Pub. No.: US 2008/0022085 A1
(43) Pub. Date: Jan. 24, 2008

(54) Server-client computer network system for carrying out cryptographic operations, and method of carrying out cryptographic operations in such a computer network system

(76) Inventor: Alain P. Hiltgen, Zurich (CH)

Correspondence Address: PAUL, HASTINGS, JANOFSKY & WALKER LLP, 875 15th Street, NW, Washington, DC, 20005, US

(21) Appl. No.: 11/368,624

(22) Filed: Mar. 7, 2006

(30) Foreign Application Priority Data
Oct. 20, 2005 (EP) 05 022 902.0

(51) Int. Cl. H04L 9/00

(52) U.S. Cl. 713/155

(57) ABSTRACT

In a server-client computer network system, for carrying out cryptographic operations via a network between a client computer workstation and a cryptography server computer system, in the client computer workstation and in the cryptography server computer system, computer software programs which are set up to communicate with each other are installed. These computer software programs are executed so that when the client computer workstation directs a request to carry out a cryptographic operation to the cryptography server computer system, the cryptography server computer system responds to it. For this purpose, the cryptography server computer system requests strong authentication from the requesting client computer workstation. As a reaction to this, the client computer workstation accesses a key of its user, under strong authentication. In the case of successful authentication, the client computer workstation receives a release to initiate just one or a few cryptographic operations using the private key. According to the invention, the private key is held on the cryptography server computer system, and the cryptographic operation(s) is/are permitted only within a defined, short period after successful authentication, to carry out the cryptographic operation(s) which application program software running on the client computer workstation has requested. The client computer workstation makes the result of the cryptographic operation(s) available to the application program software.

### BACKGROUND

1. Field of the Invention

Embodiments of the present invention relate generally to server-client computer network system for carrying out cryptographic operations, and a method of carrying out cryptographic operations in such a computer network system. More Particularity, embodiments of the present invention relate to computer network systems in which one user (out of many users) desires to initiate a secure connection to a central computer system by means of a network workstation, and which then handle data communication with the central computer system via the initiated connection.

2. Background of the Invention

One example of a user initiating a connection with, and accessing a central computer system via a secure connection using a workstation occurs in the context of so-called online banking. In this case, a customer of a bank has a network workstation (computer unit, e.g. PC, with alphanumeric display, keyboard and interface to the network, e.g. the Internet), on which a so-called browser is installed. WWW browsers are computer programs for viewing Web pages in the Internet (=WWW pages). With this network workstation, the customer can connect himself or herself via the network to the central computer system of the bank, and execute bank transactions (e.g. account enquiries, transfers, securities account movements or similar). Another scenario, which the invention also captures, is sending e-mails from a customer or partner of an institution (e.g. the bank) to the institution, in the framework of confidential exchange of writing, which is encrypted for this purpose. But Internet auctions, virtual department stores or similar are also based on such a scenario.

Such network connections are protected by a very wide variety of mechanisms from undesired intruders or criminals. These include so-called PIN/TAN methods, in which a user lets himself or herself be recognised by an institution by means of an access number and a static code which is known only to the user (personal identification number=PIN). The user can then execute certain transactions with the institution. At the end of them, the user must enter a transaction number (=TAN) which is only valid once. Such methods are widely used, but relatively insecure, since the PIN is static and is valid until the user replaces it with another one. The TAN, which is only valid once, is taken from a so-called cross-off list, which is issued to the user electronically or as copy.

Apart from theft of the PIN/TAN information, which is in writing or held as a file, it is also possible to reach this data in the network connection between the user and the institution in unpermitted fashion by a so-called man-in-the-middle attack, and to use it for criminal purposes (without the legitimate user noticing). A man-in-the-middle attack is a form of attack in which the attacker either physically, or today mostly logically, stands between the two communicating partners, and with his or her system has complete control of the data traffic between two or more network subscribers. The attacker can see the information as desired and even manipulate it. This situation can be achieved, for instance, by the attacker having control of a router, through which the data traffic is channelled. It is also possible that the attacker specifies a false destination address for the Internet communication, and thus routes the traffic through the attacker's own computer (poison routing). This form of attack can be most effectively counteracted by encrypting the data packets, in which case however the certificates of the keys should be verified via a reliable medium. Mutual authentication must therefore take place. For this purpose, the two communicating partners must have exchanged their digital certificates or a common key via another route, i.e. they must “know” each other. Otherwise, for instance, an attacker, the first time a connection is set up, can fake wrong keys for both communicating partners, and thus read even the encrypted data traffic.

To make this difficult, protocols such as the SSL (Secure Sockets Layer) transmission protocol, which was developed by Netscape, have been agreed, and make it possible to set up encrypted connections via a potentially insecure Internet connection. It is supported today by all current WWW browsers, and is used in practice (e.g. for online banking). The URL (Unique Resource Locator) of a WWW page which is transmitted encrypted according to the SSL protocol can be recognised by the prefix https:// (instead of http:// for unencrypted data transfer). Additionally, most WWW browsers indicate the connection which has been set up under the SSL protocol by a symbol (e.g. a padlock) in the status bar.

The SSL protocol consists of two layers: in the bottom layer, it is based on the SSL record protocol, the purpose of which is to encapsulate various higher level protocols. Examples are the SSL handshake protocol for authentication of client and server and agreement on which encryption method is used, or the HTTP protocol for transmitting Web pages.

There are various SSL variants, which are partly also called TLS (transport layer security). The SSL variant which is used in each case is automatically negotiated when the connection between the WWW browser and the WWW server is set up. To encrypt the data in the case of an SSL connection, the RC4 encryption method is mostly used. The cryptographic security of this algorithm depends on the length of the key which is used for encryption.

To set up an SSL connection, the WWW browser generates a random key (session key), which is used for encryption for the duration of the connection. So that the SSL connection cannot be tapped, first this session key must be transmitted by a secure path to the WWW server. To ensure this, the session key itself is encrypted by a public key method, e.g. RSA. For this purpose, the WWW server presents its public RSA key; the WWW browser encrypts the session key using it, and communicates the result back to the WWW server. The actual data communication only begins after that.

Essential for the security of the described method is the authenticity of the public key of the WWW server. A potential attacker could offer a fictitious public RSA key in a deception attempt, and continue to take the role of the “true” WWW server which the user is actually addressing. Communication would then take place in encrypted form, but the attacker would still be able to determine the clear text using the session key which the attacker knows. To make such deception attempts difficult, the public key of the WWW server carries additional information describing its identity (name of server, organisation which operates the server, etc.). The integrity of this information is protected by a digital signature; everything together is called a certificate to the X.509 standard. This certificate is issued by a certificate authority (CA) after checking the identity of the server operator.

A www browser can therefore recognise the public key of a WWW server which is unknown to it as authentic if it can check the digital signature of the certificate authority. For this purpose, it needs the public key of the certificate authority. The public keys of some certificate authorities are already known to the standard browsers; certificates of WWW servers which are signed by these certificate authorities are therefore immediately accepted. However, there is also the possibility of making the public keys of other certificate authorities known to the browser, so that their certificates too can be checked.

The public key of a certificate authority (like the public key of a WWW server) is an X.509 key, which itself can be signed by a higher-level certificate authority. Thus the browser can also check the authenticity of the certificate authority key, if it knows the higher-level certificate authority. However, only the user himself or herself can make the decision about the trustworthiness of a certificate authority which is not covered by the digital signature of another agency. If the WWW browser receives from a WWW server a certificate of which it cannot check the authenticity, the user is invited to make a decision about how to proceed further.

The steps to set up a traditional SSL connection between client and (proxy) server are as follows:

1. The client sends a connection request to the server.

2. The server responds with the same message and may send a certificate.

3. The client tries to authenticate the certificate (if it fails, the connection is terminated). This certificate contains the public key of the server.

4. After successful authentication, the client creates the “pre-master secret”, encrypts it with the public key of the server and sends it to the server. The client also generates the “master secret” from it.

5. The server decrypts the “pre-master secret” with its private key and creates the “master secret”.

6. The client and server create the “session key” from the “master secret”. This is a symmetrical key which is used once. It is used during the connection to encrypt and decrypt the data. SSL supports the DES and triple DES encryption methods, among others, for symmetrical encryption using this “session key”.

7. Using this “session key”, the client and server exchange encrypted messages and thus signal their readiness for communication.

8. The SSL connection is set up.

A proxy server is a computer program which can run on a separate computer unit or the same computer unit as the actual Web server program, and mediates in data traffic between the workstation which requests via the network and the Web server program. From the point of view of the Web server, the proxy server behaves like a client, but from the point of view of the client, it behaves like a Web server. In the simplest case, the proxy server just passes the data on. A so-called http proxy server, which mediates between the Web browser (client) and Web server, particularly in security-critical applications such as online banking, has a filter function, so that particular categories of Web pages or individual Web pages are blocked for the user, and/or accesses to them are logged. The content can also be searched for damaging programs or functions. A proxy server is also used for access control: so that the Web server cannot be freely reached via the Internet, a proxy server which is connected in front of it controls and monitors access to it. An attacker can then no longer attack the Web server directly, but only the proxy server. Access by clients to Web servers can also be made possible only via a proxy server. In this case, the proxy server can also be configured as a reverse proxy. For this purpose, it is set up logically in front of the other Web servers and application servers. Connection requests from the Internet to a Web server are processed by the proxy server, which either responds to the request completely itself or passes it on in whole or in part to the downstream Web server or one of them. The reverse proxy server represents another link in the security chain, and thus contributes to the security of the Web servers. To generate secure Web pages quickly, the SSL encryption is not done by the Web server itself but by a reverse proxy server, which is equipped with appropriate accelerated hardware.

In summary, it must be realised that the mechanisms which are available today for confidential data communication between one user out of many users (e.g. bank customers) and an institution (e.g. a bank) are insecure for a wide variety of reasons. These include that a user does not usually have the necessary technical specialist knowledge, and that the operation of the hardware and software in the case of more complex security mechanisms is too complicated for many users, who therefore reject it. Additionally, there is often too little awareness that only the highest possible discipline in dealing with security-relevant information makes it possible to prevent misuse of it and thus damage for the individual user or the institution, or at least to make it difficult for the criminal.

### BRIEF SUMMARY OF THE INVENTION

Technical Problem on which the Invention is Based

The object of the invention is to provide a secure computer network and a method of setting up a secure computer network connection so that one user (out of many users) in the network can access his or her keys, with high security against undesired accesses by third parties, by means of a network workstation.

Solution According to the Invention

To achieve this object, the invention provides a computer network system with the features of claim 1.

Technical Features of the Invention

For this purpose, in a server-client computer network system for carrying out cryptographic operations via a network between a client computer workstation and a cryptography server computer system, in the client computer workstation and in the cryptography server computer system, computer software programs which are set up to communicate with each other are installed. These computer software programs are executed so that when the client computer workstation directs a request to carry out a cryptographic operation to the cryptography server computer system, the cryptography server computer system responds to it. For this purpose, the cryptography server computer system requests strong authentication from the requesting client computer workstation. As reaction to this, the client computer workstation accesses a key of its user, under strong authentication. In the case of successful authentication, the client computer workstation receives a release to initiate just one or a few cryptographic operations using the private key. According to the invention, the private key is held on the cryptography server computer system, and the cryptographic operation(s) is/are permitted only within a defined, short period after successful authentication, to carry out the cryptographic operation(s) which application program software running on the client computer workstation has requested. The client computer workstation makes the result of the cryptographic operation(s) available to the application program software.

Technical Effects of the Invention

So-called man-in-the-middle attacks are excluded, since because of the configuration according to the invention the client computer workstation is informed with which cryptography server computer system the connection exists (server authentication), and the key is protected by the strong authentication, because it is not transmitted via the network, but always remains in the cryptography server computer system; but the private key is available to the user.

Advantageous Forms and Developments of the Invention

The cryptographic operations can include signing a hash value or decrypting a secret key.

In the case of the server-client computer network system according to the invention, the cryptography server computer system can additionally have a proxy server and/or an authentication server.

For strong authentication, a legitimation means which is valid for a short time, and/or once, and/or is dynamically generated can be exchanged between the client computer workstation and the cryptography server computer system. In particular, the legitimation means can be a password, an identifying label, or similar. However, other strong authentications are possible and usable within the framework of the present invention.

In the case of the server-client computer network system according to the invention, the strong authentication is implemented in a computer software program in the client computer workstation. The computer software program in the client computer workstation preferably requests a user, in a dialogue, to enter his or her identifier which identifies him or her to the cryptography server computer system, and after the user's identifier is entered, initiates the strong authentication.

Furthermore, in the server-client computer network system according to the invention, the strong authentication is checked in the cryptography server computer system, and if the authentication is correct, successful authentication is signalled to the client computer workstation.

According to the invention, the client computer workstation invites a user to enter his or her contract number or another identifier by which the institution, to the server computer system of which the user wishes to have access, can identify the user. After the contract number is entered, in the case of the server-client computer network system according to the invention, the client computer workstation, after his or her identifier is entered, outputs a character string for the user (e.g. on a screen or similar). The user must enter this character string into a separate computer unit (preferably within a predetermined time of a few minutes). Previously, the separate computer unit was connected to a secured chip card, and the secured chip card was activated by means of a PIN which was known to the user (e.g. by entry by the user via a keyboard of the computer unit). The separate computer unit with the chip card then combines the character string with a key which is held in the chip card, using a combination rule, and outputs a response character string to the user. The user enters this response character string into the client computer workstation (e.g. via a keyboard). The client computer workstation sends this response character string to the cryptography server computer system.

This is therefore an interactive, chip-card-based authentication system. An advantage of this method is the short time for which the key/data is valid. Also, the procedure according to the invention ensures that the code is not generated until the call is set up. This code is recalculated each time, and is only valid for a short time. A key is stored on the chip card, and is uniquely associated with a (contractual) relationship between the user and the operator of the cryptography server computer system. The content of the chip card is protected, and can neither be copied nor disclosed by third parties, because all the security elements are never transmitted via the Internet simultaneously.

According to the invention, in the server computer system (more precisely, preferably in the cryptography server computer system), using an appropriate combination rule, the character string which is output to the user is combined with the (preferably symmetrical) private key which is held in the server computer system. The result of the combination is compared with the response character string which the user entered into the client computer workstation. If they agree, successful authentication is signalled to the client computer workstation.

If the authentication is unsuccessful, the computer software program terminates communication or does not set up the desired connection in the first place.

The invention also concerns a method of carrying out cryptographic operations in a server-client computer network system via a network between a client computer workstation and a cryptography server computer system with the properties and features explained above. The invention also concerns a server computer system and a client computer workstation, which are configured and programmed to carry out this method.

Finally, a computer program product with computer-executable program object code to implement the method is also a subject of the invention. The program object code, if it is executed in one or more computers, is set up to cause a secure computer network connection according to one of the preceding claims in a server-client computer network system.

An object of the present invention is to provide a secure computer network and a method of setting up a secure computer network connection so that one user (out of many users) in the network can access his or her keys, with high security against undesired accesses by third parties, by means of a network workstation. This and other objects of embodiments of the present invention will become evident in the following detailed description and accompanying drawings.

### BRIEF DESCRIPTION OF THE DRAWINGS

Other properties, advantages, possible modifications and alternatives are illustrated in the description below of embodiments of the invention, with reference to the figures.

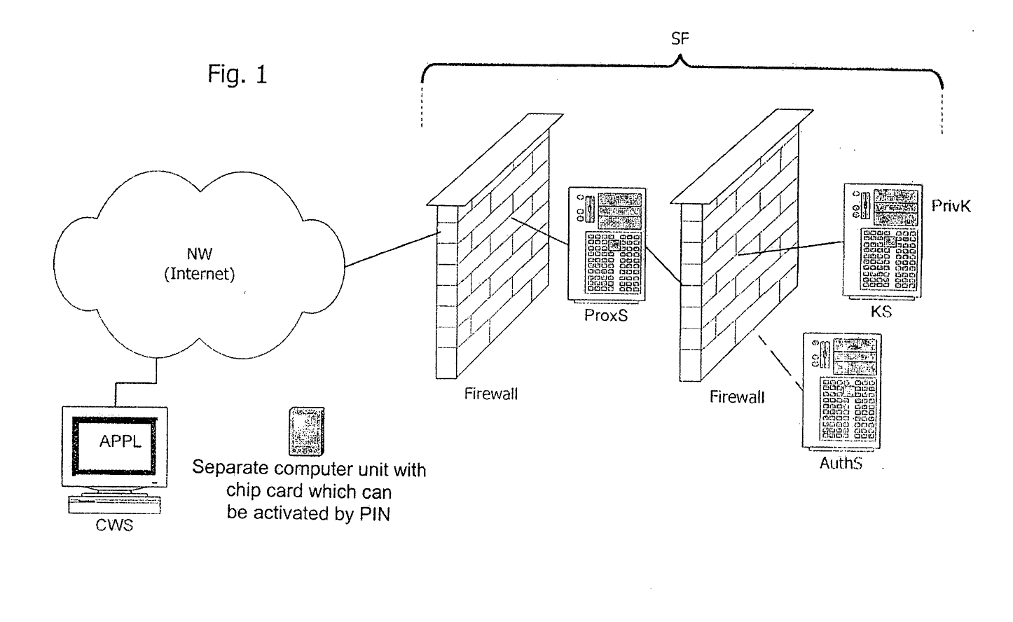

In FIG. 1, a configuration of a server-client computer network system according to the invention is shown schematically;

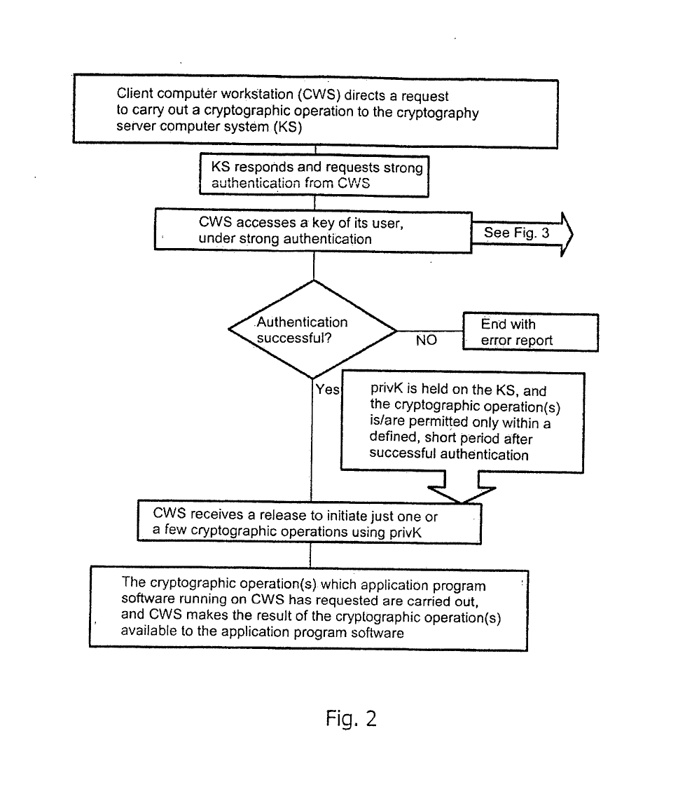

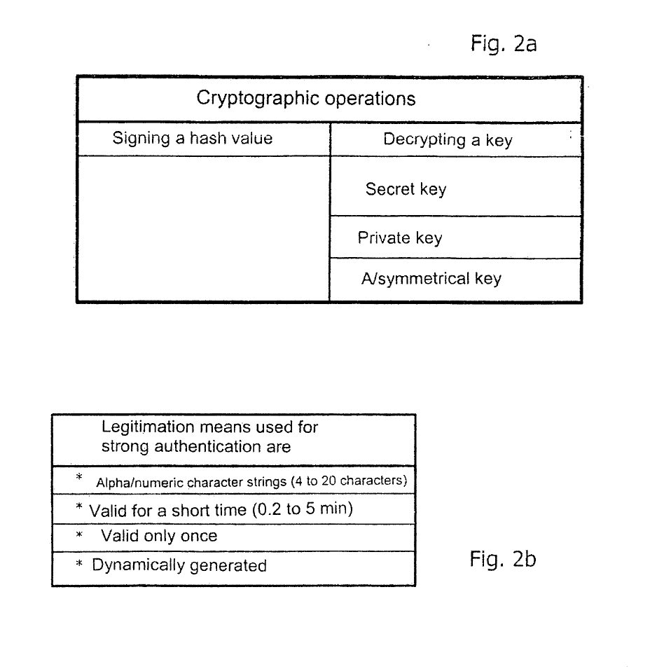

In FIG. 2, a flow of the steps which the server-client computer network system according to the invention executes is shown schematically;

In FIG. 2a, the categories of possible cryptographic operations are shown in tabular form; and

In FIG. 2b, the categories of possible cryptographic operations are shown in tabular form.

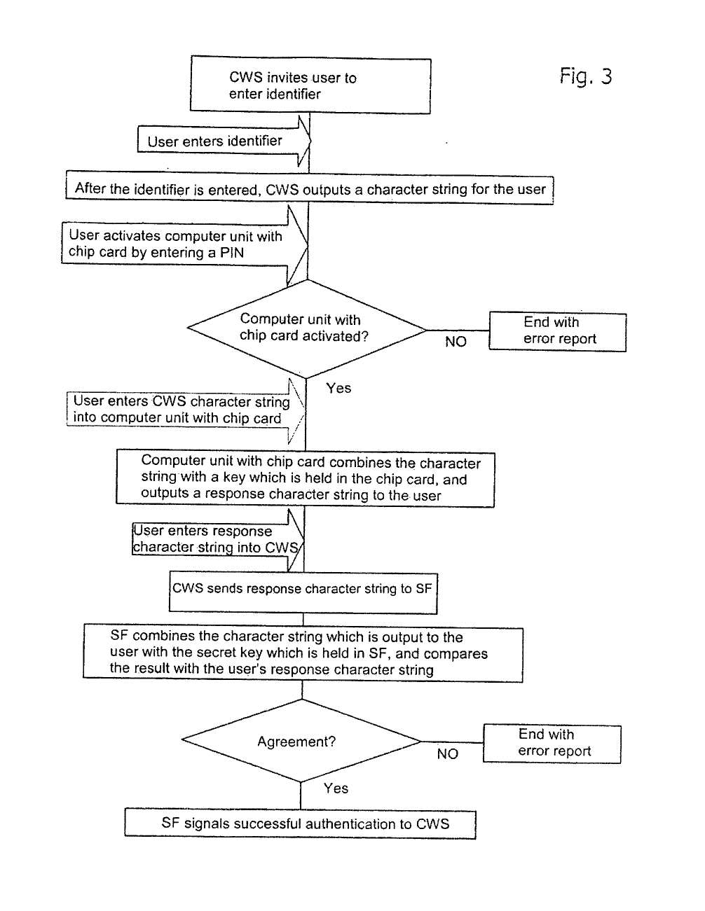

In FIG. 3, a flow of the steps which must be executed according to the invention for strong authentication is shown schematically.

### DETAILED DESCRIPTION OF THE INVENTION

FIG. 1 shows a server-client computer network system to carry out cryptographic operations via a network NW, e.g. the Internet. Communication takes place between a client computer workstation CWS, for instance the PC of a bank customer with Internet access, and a server farm SF of the bank, including, among other things, a cryptography server computer system KS. Additionally, on the side of the bank customer, there is a separate computer unit with a chip card, which can be activated by entering a PIN. As shown in FIG. 1, the server farm SF includes, as well as the cryptography server computer system KS, additionally a proxy server ProxS—which is connected in front of it—and an authentication server AuthS.

In the client computer workstation CWS and in the cryptography server computer system KS, computer software programs which are set up to communicate with each other are installed. These computer software programs are executed so that when the client computer workstation CWS directs a request to carry out a cryptographic operation to the cryptography server computer system KS, the cryptography server computer system KS responds to it.

The flow of these programs and the flow of the steps which must be executed for strong authentication are shown in FIGS. 2 and 3.

First, the cryptography server computer system KS requests strong authentication from the requesting client computer workstation CWS.

The client computer workstation CWS then accesses a key of its user, under strong authentication. The details of this are described below with reference to FIG. 3. In the case of successful authentication, the client computer workstation CWS receives a release to initiate just one or a few cryptographic operations using the private key privK. The private key privK is held on the cryptography server computer system KS. Also the cryptographic operation is permitted only within a defined, short period of about 0.2 to 5 minutes after successful authentication, to carry out a cryptographic operation which application program software Appl running on the client computer workstation CWS has requested. The client computer workstation CWS makes the result of the cryptographic operation(s) available to the application program software.

As shown in FIG. 2a, the cryptographic operations can include signing a hash value or decrypting a key, which can be a symmetrical key and/or a private key.

As shown in FIG. 2b, strong authentication can use a legitimation means which is valid for a short time, and/or once, and/or is dynamically generated, and can be, for instance, a password, an identifying label, a result of a challenge-response sequence (challenge-response method) or similar, and is exchanged between the client computer workstation CWS and the cryptography server computer system KS.

FIG. 3 shows the flows in association with strong authentication. This is—at least partly—implemented in a computer software program which runs in the client computer workstation CWS. This computer software program in the client computer workstation CWS requests a user, in a dialogue, to enter his or her identifier which identifies him or her to the cryptography server computer system KS. After the user's identifier is entered, the computer software program initiates the strong authentication.

For this purpose, the legitimation means of strong authentication is checked in the cryptography server computer system KS, and if the authentication is correct, successful authentication is signalled to the client computer workstation CWS.

The client computer workstation CWS, after his or her identifier is entered, outputs a character string for the user, and the user must enter this character string into a separate computer unit. Previously, the separate computer unit must have been connected to a secured chip card, and must have been activated by means of a PIN. The separate computer unit with the chip card combines the entered character string with a key which is held in the chip card, using a combination rule. The separate computer unit then outputs a response character string to the user. The user must enter this response character string into the client computer workstation CWS. The client computer workstation CWS sends the response character string to the cryptography server computer system KS for authentication.

In the server computer system SF, using an appropriate combination rule, the character string which is output to the user is combined with the secret key which is held in the server computer system SF. The result of this combination is compared with the response character string which the user entered into the client computer workstation. If they agree, successful authentication is signalled to the client computer workstation CWS.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. Server-client computer network system for carrying out cryptographic operations via a network (NW) between a client computer workstation (CWS) and a cryptography server computer system (KS), wherein
in the client computer workstation (CWS) and in the cryptography server computer system (KS), computer software programs which are set up to communicate with each other are installed and executed, so that when the client computer workstation (CWS) directs a request to carry out a cryptographic operation to the cryptography server computer system (KS), the cryptography server computer system (KS) responds to it,
the cryptography server computer system (KS) requesting strong authentication from the requesting client computer workstation (CWS),
upon which the client computer workstation (CWS) accesses a private key (privK) of its user, under strong authentication, and
in the case of successful authentication, the client computer workstation (CWS) receives a release to initiate just one or a few cryptographic operations using the private key (privK),
the private key (privK) being held on the cryptography server computer system (KS), and
the cryptographic operation(s) being permitted only within a defined, short period after successful authentication, in order to
carry out the cryptographic operation(s) which application program software running on the client computer workstation (CWS) has requested, the client computer workstation (CWS) making the result of the cryptographic operation(s) available to the application program software.

2. Server-client computer network system for carrying out cryptographic operations according to claim 1, wherein the cryptographic operations include signing a hash value or decrypting a key, and
the key can be symmetrical or asymmetrical, and/or a private or a secret key.

3. Server-client computer network system according to claim 1, wherein the cryptography server computer system (KS) additionally has a proxy server (ProxS) and an authentication server (RuthS).

4. Server-client computer network system according to claim 1, wherein
the strong authentication uses a legitimation means which is
valid for a short time, and/or valid once, and/or dynamic,
and is exchanged between the client computer workstation (CWS) and the cryptography server computer system (KS).

5. Server-client computer network system according to claim 4, wherein the legitimation means is a password, an identifying label, a result of a challenge-response sequence or similar.

6. Server-client computer network system according to claim 4, wherein the strong authentication is implemented in a computer software program in the client computer workstation (CWS),
the computer software program in the client computer workstation (CWS) requesting a user, preferably in a dialogue, to enter his or her identifier which identifies him or her to the cryptography server computer system (KS), and
after the user's identifier is entered, initiating the strong authentication.

7. Server-client computer network system according to claim 6, wherein in the cryptography server computer system (KS),
the legitimation means of strong authentication is checked, and
if the authentication is correct, successful authentication is signaled to the client computer workstation (CWS).

8. Server-client computer network system according to claim 6, wherein the client computer workstation (CWS), after his or her identifier is entered, outputs a character string for the user, and the user must enter this character string into a separate computer unit, which was previously connected to a secured chip card, and was activated by means of a PIN, whereupon the separate computer unit with the chip card combines the entered character string with a key which is held in the chip card, using a combination rule, and outputs to the user a response character string which the user must enter into the client computer workstation (CWS), and which the client computer workstation (CWS) sends to the cryptography server computer system (KS) for authentication.

9. Server-client computer network system according to claim 8, wherein in the server computer system (SF), using an appropriate combination rule, the character string which is output to the user is combined with the private key (privK) which is held in the server computer system (SF), and compared with the response character string which the user entered into the client computer workstation, and if they agree, successful authentication is signaled to the client computer workstation (CWS).

10. Method of carrying out cryptographic operations in a server-client computer network system via a network (NW) between a client computer workstation (CWS) and a cryptography server computer system (KS), wherein
in the client computer workstation (CWS) and in the cryptography server computer system (KS), computer software programs which are set up to communicate with each other are installed and executed, so that when the client computer workstation (CWS) directs a request to carry out a cryptographic operation to the cryptography server computer system (KS), the cryptography server computer system (KS) responds to it,
the cryptography server computer system (KS) requesting strong authentication from the requesting client computer workstation (CWS),
upon which the client computer workstation (CWS) accesses a private key (privK) of its user, under strong authentication, and in the case of successful authentication, the client computer workstation (CWS) receives a release to initiate just one or a few cryptographic operations using the private key (privK),
the private key (privK) being held on the cryptography server computer system (KS), and
the cryptographic operation(s) being permitted only within a defined, short period after successful authentication, in order to carry out the cryptographic operation(s) which application program software running on the client computer workstation (CWS) has requested, the client computer workstation (CWS) making the result of the cryptographic operation(s) available to the application program software.

11. Method according to claim 10, wherein the cryptographic operations include signing a hash value or decrypting a secret key.

12. Method according to claim 10, wherein the cryptography server computer system (KS) additionally has a proxy server (ProxS) and an authentication server (AuthS).

13. Method according to claim 10, wherein
the strong authentication is a legitimation means which is
valid for a short time, and/or valid once, and/or dynamic,
and which is exchanged between the client computer workstation (CWS) and the cryptography server computer system (KS).

14. Method according to claim 13, wherein the legitimation means is a password, an identifying label or similar.

15. Method according to claim 13, wherein the strong authentication is implemented in a computer software program in the client computer workstation TWO,
the computer software program in the client computer workstation (CWS) requesting a user, in a dialogue, to enter his or her identifier which identifies him or her to the cryptography server computer system (KS), and
after the user's identifier is entered, initiating the strong authentication.

16. Method according to claim 15, wherein in the cryptography server computer system (KS),
the strong authentication is checked, and
if the authentication is correct, successful authentication is signaled to the client computer workstation (CWS).

17. Method according to claim 15, wherein the client computer workstation (CWS), after his or her identifier is entered, outputs a character string for the user, and the user must enter this character string into a separate computer unit, which was previously connected to a secured chip card, and was activated by means of a PIN, whereupon the separate computer unit with the chip card combines the entered character string with a key which is held in the chip card, using a combination rule, and outputs to the user a response character string which the user must enter into the client computer workstation (CWS), and
which the client computer workstation (CWS) sends to the cryptography server computer system (KS) for authentication.

18. Method according to claim 17, wherein in the server computer system (SF), using an appropriate combination rule, the character string which is output to the user is combined with the private key (privK) which is held in the server computer system (SF), and compared with the response character string which the user entered into the client computer workstation, and if they agree, successful authentication is signaled to the client computer workstation (CWS).

19. Server computer system (SF), configured and programmed to execute the method of claim 10.

20. Client computer workstation (CWS), configured and programmed to execute the method of claim 10.

21. Computer program product with computer-executable program object code for performing the method of claim 10, which, if it is executed in one or more computers, is set up to cause a secure computer network connection in a server-client computer network system.
